(19) United States
(12) Patent Application Publication
(10) Pub. No.: US 2025/0077093 A1
(43) Pub. Date: Mar. 6, 2025

(54) SYSTEMS AND METHODS FOR RELIABILITY-BASED MEMORY POOL MANAGEMENT

(71) Applicant: Samsung Electronics Co., Ltd., Suwon-si (KR)

(72) Inventors: Changhee JUNG, Lafayette, IN (US); Yang Seok KI, Palo Alto, CA (US)

(21) Appl. No.: 18/524,121

(22) Filed: Nov. 30, 2023

Related U.S. Application Data
(60) Provisional application No. 63/536,662, filed on Sep. 5, 2023.

(51) Int. Cl. G06F 3/06

(52) U.S. Cl. CPC G06F 3/0619; G06F 3/0631; G06F 3/0679

(57) ABSTRACT

Provided is a method for memory pool management, the method including receiving, by a memory-pool manager, a memory request from an application, the memory-pool manager being communicatively coupled to a memory pool including a first memory module, of a first type, and a second memory module, of a second type, the first type being different from the second type, determining, by the memory-pool manager, based on the memory request, an error tolerance associated with the application, and allocating a memory space from the first memory module or from the second memory module to the application based on the error tolerance.

### CROSS-REFERENCE TO RELATED APPLICATION(S)

This application claims priority to, and benefit of, U.S. Provisional Application Ser. No. 63/536,662, filed on Sep. 5, 2023, entitled “RELIABILITY-HETEROGENEOUS CXL-BASED MEMORY POOL MANAGEMENT,” the entire content of which is incorporated herein by reference.

### FIELD

Aspects of some embodiments of the present disclosure relate to systems and methods for memory pool management in computing systems, and more particularly, to reliability-based memory pool management.

### BACKGROUND

In the field of computers, a computing system may include a host and one or more memory devices connected to (e.g., communicatively coupled to) the host. Such computing systems have become increasingly popular, in part, for allowing many different users to share the computing resources of the system. Memory requirements have increased over time as the number of users of such systems and the number and complexity of applications running on such systems have increased.

The present background section is intended to provide context only, and the disclosure of any embodiment or concept in this section does not constitute an admission that said embodiment or concept is prior art.

### SUMMARY

Aspects of some embodiments of the present disclosure are directed to computing systems, and may provide improvements to memory pool management.

According to some embodiments of the present disclosure, there is provided a method for memory pool management, the method including receiving, by a memory-pool manager, a memory request from an application, the memory-pool manager being communicatively coupled to a memory pool including a first memory module, of a first type, and a second memory module, of a second type, the first type being different from the second type, determining, by the memory-pool manager, based on the memory request, an error tolerance associated with the application, and allocating a memory space from the first memory module or from the second memory module to the application based on the error tolerance.

The first memory module may include a first memory having a higher reliability than a second memory of the second memory module.

The first memory module may store a recovery code.

The memory-pool manager may determine the error tolerance based on a parameter of the memory request.

The memory-pool manager may determine the error tolerance based on inputting a fault into the application.

The memory-pool manager may determine the error tolerance based on analyzing an output associated with inputting the fault into the application.

The memory-pool manager may determine the error tolerance based on a probability of an incorrect output.

The memory-pool manager may calculate the probability of the incorrect output based on a processing circuit associated with the memory pool.

The memory-pool manager may be in communication with the memory pool via a cache-coherent protocol.

According to some other embodiments of the present disclosure, there is provided a system including a processing circuit communicatively coupled to a memory pool including a first memory module, of a first type, and a second memory module, of a second type, the first type being different from the second type, and a computer-readable medium storing instructions that, based on being executed by the processing circuit, cause the processing circuit to perform receiving a memory request from an application, determining, based on the memory request, an error tolerance associated with the application, and allocating a memory space from the first memory module or from the second memory module to the application based on the error tolerance.

The first memory module may include a first memory having a higher reliability than a second memory of the second memory module.

The first memory module may store a recovery code.

The processing circuit may determine the error tolerance based on a parameter of the memory request.

The processing circuit may determine the error tolerance based on inputting a fault into the application.

The processing circuit may determine the error tolerance based on a probability of an incorrect output.

The computer-readable medium may be distinct from the first memory module and the second memory module, and the processing circuit may be in communication with the memory pool via a cache-coherent protocol.

According to some other embodiments of the present disclosure, there is provided a device including a processing means communicatively coupled to a memory pool including a first memory module, of a first type, and a second memory module, of a second type, the first type being different from the second type, and a computer-readable medium storing instructions that, based on being executed by the processing means, cause the processing means to perform receiving a memory request from an application, determining, based on the memory request, an error tolerance associated with the application, and allocating a memory space from the first memory module or from the second memory module to the application based on the error tolerance.

The computer-readable medium may be distinct from the first memory module and the second memory module, and the first memory module may include a first memory having a higher reliability than a second memory of the second memory module.

The processing means may determine the error tolerance based on inputting a fault into the application.

The processing means may determine the error tolerance based on a probability of an incorrect output.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a system diagram depicting a system for memory pool management, according to some embodiments of the present disclosure.

FIG. 2 is a flowchart depicting example operations of a method for reliability classification in the system for memory pool management, according to some embodiments of the present disclosure.

FIG. 3 is a flowchart depicting example operations of a method for memory pool management, according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Any of the functionalities described herein, including any of the functionalities that may be implemented with a host, a device, and/or the like or a combination thereof, may be implemented with hardware, software, firmware, or any combination thereof including, for example, hardware and/or software combinational logic, sequential logic, timers, counters, registers, state machines, volatile memories such as dynamic RAM (DRAM) and/or static RAM (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application-specific ICs (ASICs), central processing units (CPUs) including complex instruction set computer (CISC) processors and/or reduced instruction set computer (RISC) processors, graphics processing units (GPUs), neural processing units (NPUs), tensor processing units (TPUs), data processing units (DPUs), and/or the like, executing instructions stored in any type of memory. In some embodiments, one or more components may be implemented as a system-on-a-chip (SoC).

Any of the computational devices disclosed herein may be implemented in any form factor, such as 3.5 inch, 2.5 inch, 1.8 inch, M.2, Enterprise and Data Center Standard Form Factor (EDSFF), NF1, and/or the like, using any connector configuration such as Serial Advanced Technology Attachment (SATA), Small Computer System Interface (SCSI), Serial Attached SCSI (SAS), U.2, and/or the like. Any of the computational devices disclosed herein may be implemented entirely or partially with, and/or used in connection with, a server chassis, server rack, data room, data center, edge data center, mobile edge data center, and/or any combinations thereof.

Any of the devices disclosed herein that may be implemented as storage devices may be implemented with any type of nonvolatile storage media based on solid-state media, magnetic media, optical media, and/or the like. For example, in some embodiments, a storage device (e.g., a computational storage device) may be implemented as an SSD based on not-AND (NAND) flash memory, persistent memory such as cross-gridded nonvolatile memory, memory with bulk resistance change, PCM, and/or the like, or any combination thereof.

Any of the communication connections and/or communication interfaces disclosed herein may be implemented with one or more interconnects, one or more networks, a network of networks (e.g., the Internet), and/or the like, or a combination thereof, using any type of interface and/or protocol. Examples include Peripheral Component Interconnect Express (PCIe), non-volatile memory express (NVMe), NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, SATA, SCSI, SAS, Internet Wide Area RDMA Protocol (iWARP), and/or a coherent protocol, such as Compute Express Link (CXL), CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced extensible Interface (AXI), any generation of wireless network including 2G, 3G, 4G, 5G, 6G, and/or the like, any generation of Wi-Fi, Bluetooth, near-field communication (NFC), and/or the like, or any combination thereof.

In some embodiments, a software stack may include a communication layer that may implement one or more communication interfaces, protocols, and/or the like such as PCIe, NVMe, CXL, Ethernet, NVMe-oF, TCP/IP, and/or the like, to enable a host and/or an application running on the host to communicate with a computational device or a storage device.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As mentioned above, in the field of computers, a computing system may include a host and one or more memory devices connected to (e.g., communicatively coupled to) the host. The memory devices may be located on the host or may be located remotely from the host. The memory devices may be used by applications running on the host. Different applications may process different workloads having different error tolerance levels. The memory devices may have different levels of reliability (e.g., dependability). For example, some of the memory devices may be high-reliability memory devices (e.g., relatively higher-reliability memory devices with relatively strong data protection), including recovery codes, such as error correction code (ECC) memory modules, to provide error detection and error correction capabilities. Some of the memory devices may be lower-reliability memory devices (e.g., memory devices with relatively weak data protection), which do not include ECC memory modules. The high-reliability memory devices may be more expensive than the lower-reliability memory devices. In some systems, a memory pool may include only one type of memory device. Accordingly, in such embodiments, some workloads having a high error tolerance, which may not be suited for (e.g., may waste) high-reliability memory devices, may still be allocated high-reliability memory devices.

Aspects of some embodiments of the present disclosure accommodate different reliability characteristics (e.g., demands) of applications (or workloads) by providing a heterogeneous memory pool including both high-reliability memory devices (e.g., ECC memory modules) and lower-reliability memory devices (e.g., non-ECC memory modules). A memory-pool manager and a reliability classifier may allocate memory devices to a given application based on the reliability characteristics (or error tolerance) of the application. For example, reliability-critical applications may be allocated high-reliability memory devices while other applications may be allocated lower-reliability memory devices.

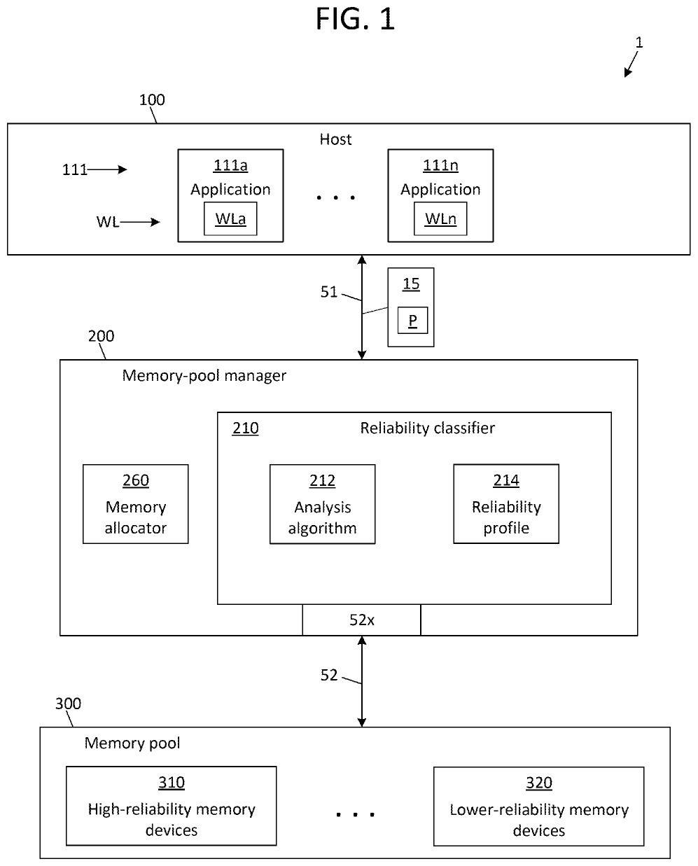

FIG. 1 is a system diagram depicting a system for memory pool management, according to some embodiments of the present disclosure.

Referring to FIG. 1, the system 1 may include a host 100, a memory-pool manager 200, and a memory pool 300. One or more applications 111 (e.g., a first application 111a through an n-th application 111n) may run on the host 100. The applications 111 may process different workloads WL (e.g., a first workload WLa through an n-th workload WLn). The applications 111 may send memory requests 15 to the memory-pool manager 200 to process their respective workloads WL. The memory requests 15 may include one or more parameters P. The parameters P may indicate characteristics of memory spaces requested by the applications 111. For example, the parameters P may include one or more of: a host Internet Protocol (IP) address associated with a requesting application 111; a container identifier (ID) for the requested memory space; a capacity of the requested memory space; a bandwidth of the requested memory space; a latency of the requested memory space; a duration for using the requested memory space; a deallocation option for the requested memory space (e.g., free, sanitization, or zeroing); and/or a reliability for the requested memory space (e.g., high reliability, low reliability (e.g., relatively low reliability), or opportunistic reliability). As used herein, “opportunistic reliability” refers to an application that is flexible to take advantage of present circumstances (e.g., present memory availability) based on a policy. As used herein, “free” (also referred to as “deallocation”) refers to making a memory chunk available for memory allocation (e.g., for future memory allocation), wherein data previously written to a memory location of the memory chunk remains in the memory location after deallocation. As used herein, “sanitization” (also referred to as “zeroing”) refers to wiping out data, which has been freed, from the memory location, such that the data is not present when the memory location is requested for memory allocation (e.g., for future memory allocation).

The memory-pool manager 200 may be local to the host 100 or may be remote from the host 100. In some embodiments, the memory-pool manager 200 may be connected to the host 100 via a first data path 51 that is capable of transferring data in accordance with a cache-coherent protocol (e.g., in accordance with CXL). The memory-pool manager 200 may include a reliability classifier 210, a memory allocator 260, and a memory expander 52x. The reliability classifier 210 may include (e.g., may implement) an analysis algorithm 212. The reliability classifier 210 may include a reliability profile 214. The memory-pool manager 200 may determine an error tolerance of a given application 111 based on using the analysis algorithm 212 to analyze memory requests 15 from the application 111. The memory-pool manager 200 may manage the reliability profile 214 as a reference in determining an error tolerance of different applications 111.

The analysis algorithm 212 may perform static or dynamic determinations of the error tolerance of a given application 111. For example, the analysis algorithm 212 may statically determine whether a given application 111 has already been determined to have low, high, or opportunistic reliability characteristics. If not already determined, the analysis algorithm may statically perform a statistical fault injection (SFI) or may dynamically perform a memory vulnerability factor (MVF) analysis. SFI may quantify the reliability of a given application 111 by running the application 111 one or more times (e.g., many times) with a fault injected and analyzing the program outputs. For example, the memory-pool manager 200 may input the fault into the application 111 and analyze an output of the application 111 that is associated with inputting the fault into the application 111. In some embodiments, the reliability classifier 210 may be populated with pre-generated SFI campaign results of target applications. MVF may quantify the reliability of a given application 111 (while the application 111 is running) with the probability of incorrect program outputs. In some embodiments, the probability of incorrect program outputs may be calculated based on vulnerable time divided by the sum of safe time and vulnerable time, wherein “vulnerable time” refers to a period of time (e.g., periods of time) between a write of data to a memory location (e.g., to each memory location) and a last read of the data, and “safe time” refers to an amount of time (e.g., amounts of time) a memory location's (e.g., each memory location's) data remains in memory since a last read and before it is overwritten. For example, if a memory access sequence includes (i) a write at a first time t1, (ii) a read at a second time t2, (iii) a write at a third time t3, (iv) a read at a fourth time t4, and (v) a write at a fifth time t5, then the “vulnerable time” would be calculated as t2 minus t1 plus t4 minus t3, and the “safe time” would be calculated as t3 minus t2 plus t5 minus t4. The memory allocator 260 may allocate memory to the applications 111 based on the results of the analysis algorithm 212. In some embodiments the MVF may be calculated based on a processing engine (e.g., a processing circuit) associated with the memory pool 300. For example, the memory-pool manager 200 may calculate a probability of an incorrect program output based on a processing circuit associated with (e.g., a processing circuit within) a memory expander (e.g., a CXL expander) of the memory pool 300.

The memory expander 52x may allow the memory-pool manager to manage a heterogeneous memory pool of memory devices of different types (e.g., high-reliability types and lower-reliability types). For example, the memory expander 52x may put the memory devices into the local host 100 and may allow the memory-pool manager 200 to access and manage a group of memory devices. In some embodiments, the memory expander 52x may send data to the memory devices of the memory pool 300 via a second data path 52 in accordance with a cache-coherent protocol (e.g., in accordance with CXL).

The memory pool 300 may include a variety of memory devices. For example, the memory pool 300 may include high-reliability memory devices 310 and lower-reliability memory devices 320. In some embodiments, the memory devices may include DRAM-based modules, such as dual in-line memory modules (DIMMs). For example, the high-reliability memory devices 310 may include ECC DIMMs and the lower-reliability memory devices 320 may include non-ECC DIMMs and/or ECC DIMMs with lower error detection and/or lower error correction capabilities than the ECC DIMMs of the high-reliability memory devices 310.

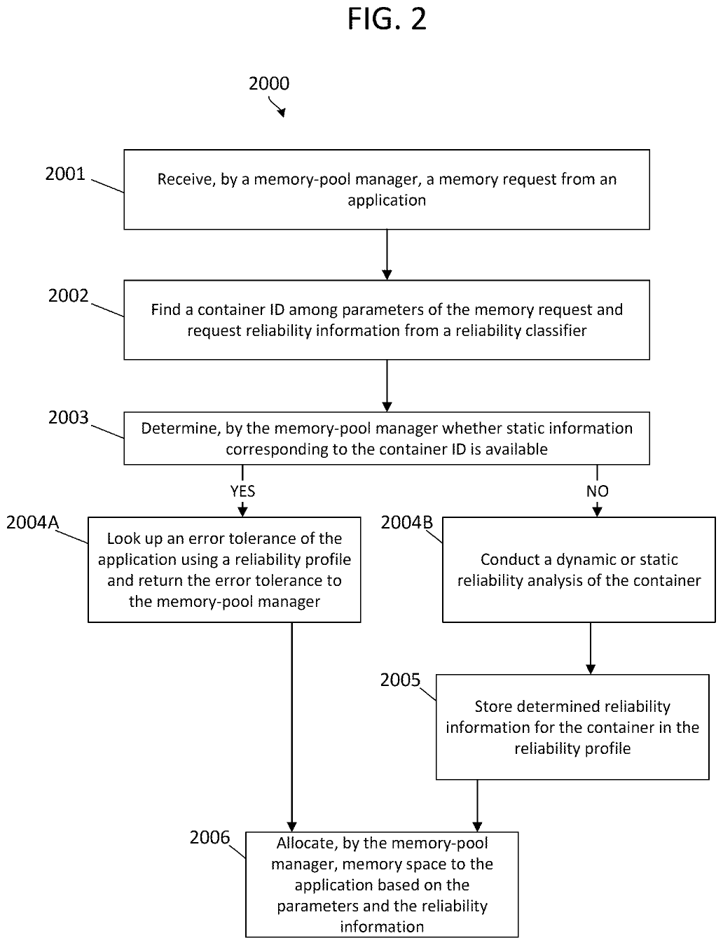

FIG. 2 is a flowchart depicting example operations of a method for reliability classification in the system for memory pool management, according to some embodiments of the present disclosure.

Referring to FIG. 2, the method 2000 may include the following example operations. An application 111 may send a memory request 15 to a memory-pool manager 200, the memory request 15 may include one or more parameters P (operation 2001). The memory-pool manager 200 may find a container ID among the parameters P and may request reliability information from a reliability classifier 210 (operation 2002). The memory-pool manager 200 may determine whether the reliability classifier 210 has static information (e.g., predetermined information regarding the application's error tolerance (or reliability level)) corresponding to the container ID (operation 2003). If static information is available, the memory-pool manager 200 may look up the error tolerance of the application 111 using a reliability profile 214 and the container ID and may return the error tolerance (operation 2004A). For example, if the error tolerance is high, the application 111 may be suited for a non-ECC memory device. If the error tolerance is weak, the application 111 may be suited for an ECC memory device. If the error tolerance is opportunistic, the application 111 may be suited for a non-ECC memory device and/or an ECC memory device based on a policy associated with the application 111. If, on the other hand, static information is not available for the application 111, the memory-pool manager 200 may conduct a dynamic reliability analysis of the container using MVF or may conduct a static reliability analysis of the container using SFI (operation 2004B). The memory-pool manager 200 may store the determined reliability information for the container in the reliability profile 214 (operation 2005). The memory-pool manager 200 may allocate a memory space to the application 111 based on the parameters P and the reliability information (operation 2006).

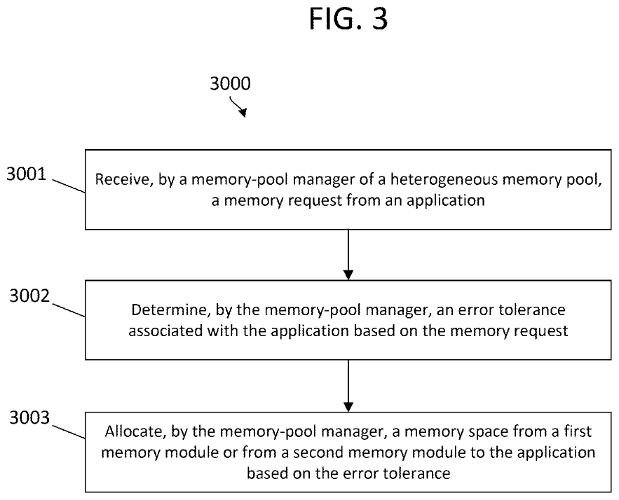

FIG. 3 is a flowchart depicting example operations of a method for memory pool management, according to some embodiments of the present disclosure.

Referring to FIG. 3, the method 3000 may include the following example operations. A memory-pool manager 200 may receive a memory request 15 from an application 111 (operation 3001). The memory-pool manager 200 may be communicatively coupled to (e.g., in communication with) a memory pool 300 comprising a first memory module of a first type and comprising a second memory module of a second type (e.g., the memory pool 300 may be a reliability-heterogeneous memory pool). For example, the first memory module may be a high-reliability memory module and the second memory module may be a lower-reliability memory module. For example, the first memory module may include a first memory having a higher reliability than a second memory of the second memory module. The memory-pool manager 200 may determine an error tolerance (or reliability information) associated with the application 111 based on the memory request 15. The memory-pool manager 200 may allocate a memory space from the first memory module or from the second memory module to the application 111 based on the error tolerance (or reliability information).

Accordingly, aspects of some embodiments of the present disclosure may provide improvements to memory pool management by providing an application-tailored reliability mechanism that may add flexibility to, and reduce the cost of, building reliable memory systems.

Example embodiments of the disclosure may extend to the following statements, without limitation:

Statement 1. An example method includes: receiving, by a memory-pool manager, a memory request from an application, the memory-pool manager being communicatively coupled to a memory pool including a first memory module, of a first type, and a second memory module, of a second type, the first type being different from the second type, determining, by the memory-pool manager, based on the memory request, an error tolerance associated with the application, and allocating a memory space from the first memory module or from the second memory module to the application based on the error tolerance.

Statement 2. An example method includes the method of statement 1, wherein the first memory module includes a first memory having a higher reliability than a second memory of the second memory module.

Statement 3. An example method includes the method of any of statements 1 and 2, wherein the first memory module stores a recovery code.

Statement 4. An example method includes the method of any of statements 1-3, wherein the memory-pool manager determines the error tolerance based on a parameter of the memory request.

Statement 5. An example method includes the method of any of statements 1-3, wherein the memory-pool manager determines the error tolerance based on inputting a fault into the application.

Statement 6. An example method includes the method of any of statements 1-3 and 5, wherein the memory-pool manager determines the error tolerance based on analyzing an output associated with inputting the fault into the application.

Statement 7. An example method includes the method of any of statements 1-3, wherein the memory-pool manager determines the error tolerance based on a probability of an incorrect output.

Statement 8. An example method includes the method of any of statements 1-3 and 7, wherein the memory-pool manager calculates the probability of the incorrect output based on a processing circuit associated with the memory pool.

Statement 9. An example method includes the method of any of statements 1-8, wherein the memory-pool manager is in communication with the memory pool via a cache-coherent protocol.

Statement 10. An example system for performing the method of any of statements 1-9 includes a processing circuit communicatively coupled to the memory pool and a computer-readable medium storing instructions that, based on being executed by the processing circuit, cause the processing circuit to perform the method of any of statements 1-9.

Statement 11. An example device for performing the method of any of statements 1-9 includes a processing means communicatively coupled to a memory pool and a computer-readable medium storing instructions that, based on being executed by the processing means, cause the processing means to perform the method of any of statements 1-9.

While embodiments of the present disclosure have been particularly shown and described with reference to the embodiments described herein, it will be understood by those of ordinary skill in the art that various changes in form and details may be made therein without departing from the spirit and scope of the present disclosure as set forth in the following claims and their equivalents.

What is claimed is:

1. A method for memory pool management, the method comprising:
receiving, by a memory-pool manager, a memory request from an application, the memory-pool manager being communicatively coupled to a memory pool comprising a first memory module, of a first type, and a second memory module, of a second type, the first type being different from the second type;
determining, by the memory-pool manager, based on the memory request, an error tolerance associated with the application; and
allocating a memory space from the first memory module or from the second memory module to the application based on the error tolerance.

2. The method of claim 1, wherein the first memory module comprises a first memory having a higher reliability than a second memory of the second memory module.

3. The method of claim 2, wherein the first memory module stores a recovery code.

4. The method of claim 1, wherein the memory-pool manager determines the error tolerance based on a parameter of the memory request.

5. The method of claim 1, wherein the memory-pool manager determines the error tolerance based on inputting a fault into the application.

6. The method of claim 5, wherein the memory-pool manager determines the error tolerance based on analyzing an output associated with inputting the fault into the application.

7. The method of claim 1, wherein the memory-pool manager determines the error tolerance based on a probability of an incorrect output.

8. The method of claim 7, wherein the memory-pool manager calculates the probability of the incorrect output based on a processing circuit associated with the memory pool.

9. The method of claim 1, wherein the memory-pool manager is in communication with the memory pool via a cache-coherent protocol.

10. A system comprising:
a processing circuit communicatively coupled to a memory pool comprising a first memory module, of a first type, and a second memory module, of a second type, the first type being different from the second type; and
a computer-readable medium storing instructions that, based on being executed by the processing circuit, cause the processing circuit to perform:
receiving a memory request from an application;
determining, based on the memory request, an error tolerance associated with the application; and
allocating a memory space from the first memory module or from the second memory module to the application based on the error tolerance.

11. The system of claim 10, wherein the first memory module comprises a first memory having a higher reliability than a second memory of the second memory module.

12. The system of claim 11, wherein the first memory module stores a recovery code.

13. The system of claim 10, wherein the processing circuit determines the error tolerance based on a parameter of the memory request.

14. The system of claim 10, wherein the processing circuit determines the error tolerance based on inputting a fault into the application.

15. The system of claim 10, wherein the processing circuit determines the error tolerance based on a probability of an incorrect output.

16. The system of claim 10, wherein:
the computer-readable medium is distinct from the first memory module and the second memory module; and
the processing circuit is in communication with the memory pool via a cache-coherent protocol.

17. A device comprising:
a processing means communicatively coupled to a memory pool comprising a first memory module, of a first type, and a second memory module, of a second type, the first type being different from the second type; and
a computer-readable medium storing instructions that, based on being executed by the processing means, cause the processing means to perform:
receiving a memory request from an application;
determining, based on the memory request, an error tolerance associated with the application; and
allocating a memory space from the first memory module or from the second memory module to the application based on the error tolerance.

18. The device of claim 17, wherein:
the computer-readable medium is distinct from the first memory module and the second memory module; and
the first memory module comprises a first memory having a higher reliability than a second memory of the second memory module.

19. The device of claim 17, wherein the processing means determines the error tolerance based on inputting a fault into the application.

20. The device of claim 17, wherein the processing means determines the error tolerance based on a probability of an incorrect output.
